(19) United States
(12) Patent Application Publication
(10) Pub. No.: US 2024/0002648 A1
(43) Pub. Date: Jan. 4, 2024

(54) SHEET CONVEYANCE ROLLER RUBBER COMPOSITION AND SHEET CONVEYANCE ROLLER

(71) Applicant: Sumitomo Rubber Industries, Ltd., Kobe-shi (JP)

(72) Inventors: Masashi HAMAKUBO, Kobe-shi (JP); Ryosuke FUJII, Kobe-shi (JP)

(73) Assignee: Sumitomo Rubber Industries, Ltd., Kobe-shi (JP)

(21) Appl. No.: 18/210,242

(22) Filed: Jun. 15, 2023

(30) Foreign Application Priority Data
Jul. 1, 2022 (JP) 2022-107179

(51) Int. Cl. C08L 23/16; C08K 5/14; B29C 48/00

(52) U.S. Cl. CPC C08L 23/16; C08K 5/14; B29C 48/022; B29K 2023/16

(57) ABSTRACT

An object of the present disclosure is to provide a rubber composition from which a sheet conveyance roller having an excellent friction coefficient can be produced. The present disclosure provides a sheet conveyance roller rubber composition containing a base rubber and a petroleum resin, wherein the base rubber contains an ethylene-α-olefin copolymer. The sheet conveyance roller rubber composition is preferably obtained by kneading the petroleum resin and the base rubber containing the ethylene-α-olefin copolymer at a temperature equal to or higher than a softening point of the petroleum resin.

### FIELD OF THE DISCLOSURE

The present disclosure relates to a rubber composition used for forming a sheet conveyance roller.

### DESCRIPTION OF THE RELATED ART

Various sheet conveyance rollers are assembled into sheet conveyance structures in an image forming apparatus such as an electrostatic copying machine, a laser printer, a plain paper facsimile machine, a multifunction peripheral thereof and an ink-jet printer, or machinery such as an automatic teller machine (ATM). The sheet conveyance roller frictionally conveys a sheet such as a paper or a plastic film while rotating being in contact with the sheet.

As a material of the sheet conveyance roller, an ethylene-propylene-diene monomer copolymer (EPDM) is often used from the viewpoint of price and ozone resistance property. In recent years, the sheets used in the image forming apparatus or the like have various types, and the sheet conveyance roller is sometimes required to have a high friction coefficient. Thus, a technology for increasing a friction coefficient of a roller using EPDM has been proposed.

For example, JP 2020-2271 A discloses a rubber composition using a non-oil extended EPDM and an oil extended EPDM in combination as EPDM, and a rubber composition containing a non-oil extended EPDM, an oil extended EPDM, and an isoprene rubber.

### SUMMARY OF THE DISCLOSURE

An object of the present disclosure is to provide a rubber composition forming a sheet conveyance roller having an excellent friction coefficient.

The present disclosure that has solved the above problem provides a sheet conveyance roller rubber composition containing a base rubber and a petroleum resin, wherein the base rubber contains an ethylene-α-olefin copolymer. If the rubber composition contains an ethylene-α-olefin copolymer as a base rubber, and a petroleum resin, the obtained roller has an improved friction coefficient.

According to the present disclosure, a sheet conveyance roller having an excellent friction coefficient can be formed.

### BRIEF DESCRIPTION OF THE DRAWINGS

FIG. 1 is a perspective view showing one example of the sheet conveyance roller according to the present disclosure, and

FIG. 2 is a schematic figure illustrating the friction coefficient measurement method.

### DESCRIPTION OF THE PREFERRED EMBODIMENT

### <Sheet Conveyance Roller Rubber Composition>

The sheet conveyance roller rubber composition (hereinafter, sometimes simply referred to as “rubber composition”) contains an ethylene-α-olefin copolymer as a base rubber, and a petroleum resin.

### (Base Rubber)

The rubber composition contains an ethylene-α-olefin copolymer as a base rubber. The ethylene-α-olefin copolymer is a copolymer including at least ethylene and an α-olefin as a constituent component. In addition, the ethylene-α-olefin copolymer also includes an ethylene-α-olefin-diene copolymer having a double bond introduced in the main chain by adding a small amount of a diene component to ethylene and the α-olefin. The ethylene-α-olefin copolymer may be used solely, or at least two of them may be used in combination.

Examples of the α-olefin include propylene, 1-butene, 1-hexene, and 1-octene.

Examples of the diene component include ethylidene norbornene (ENB), 1,4-hexadiene (1,4-HD), and dicyclopentadiene (DCP), and ethylidene norbornene is preferable.

Examples of the ethylene-α-olefin copolymer include an ethylene-propylene copolymer (EPM), an ethylene-butene copolymer (EBR), and an ethylene-octene copolymer (EOR). In addition, examples of the ethylene-α-olefin-diene copolymer include an ethylene-propylene-diene copolymer (EPDM), an ethylene-butene-diene copolymer (EBDM), and an ethylene-propylene-butene-diene copolymer (EPBDM).

The amount of the ethylene component in the ethylene-α-olefin copolymer is preferably 40 mass % or more, more preferably 42 mass % or more, and even more preferably 43 mass % or more, and is preferably 79 mass % or less, more preferably 78 mass % or less, and even more preferably 77 mass % or less. If the amount of the ethylene unit falls within the above range, the commercial product is easily available, and a rubber having better processibility and more suitable for the sheet conveyance roller is obtained.

In the case that the ethylene-α-olefin-diene copolymer is used as the ethylene-α-olefin copolymer, the amount of the diene component is preferably 0.5 mass % or more, more preferably 0.7 mass % or more, and even more preferably 1.0 mass % or more, and is preferably 15 mass % or less, more preferably 14 mass % or less, and even more preferably 13 mass % or less. If the amount of the diene unit falls within the above range, the commercial product is easily available, and a rubber having better processibility and more suitable for the sheet conveyance roller is obtained.

The ethylene-α-olefin copolymer includes an oil extended type having an extending oil added to adjust flexibility, and a non-oil extended type having no extending oil, and each of them may be used. It is noted that in the case of the oil extended type, the amount of the added extending oil is treated as the amount of a processing aid.

The ethylene-α-olefin copolymer is preferably contained as a principal component. The amount of the ethylene-α-olefin copolymer in the rubber component is preferably 50 mass % or more, more preferably 80 mass % or more, and even more preferably 90 mass % or more. It is noted that in the present disclosure, it is also a preferable embodiment that the base rubber consists of the ethylene-α-olefin copolymer.

Examples of the other rubber component include a diene-based rubber such as a natural rubber (NR), an isoprene rubber (IR), a butadiene rubber (BR), a styrene butadiene rubber (SBR), an acrylonitrile butadiene rubber (NBR) and a chloroprene rubber (CR); and a non-diene-based rubber such as an epichlorohydrin-based rubber, an acrylic rubber, a butyl rubber, and a silicone rubber. These other rubber components may be used solely, or at least two of them may be used in combination.

The rubber composition also preferably contains the diene-based rubber as the base rubber, particularly preferably contains the isoprene rubber or natural rubber as the base rubber. If the isoprene rubber or natural rubber is contained as the base rubber, the obtained sheet conveyance roller has further enhanced friction coefficient.

In the case that the base rubber contains the diene-based rubber, the amount of the diene-based rubber is preferably 5 mass % or more, more preferably 10 mass % or more, and even more preferably 15 mass % or more, and is preferably 45 mass % or less, more preferably 40 mass % or less, even more preferably 35 mass % or less, and most preferably 30 mass % or less in 100 mass % of the base rubber. If the amount of the diene-based rubber falls within the above range, the production cost of the obtained sheet conveyance roller is reduced while maintaining a high friction coefficient.

In the case that the base rubber contains the diene-based rubber, the mass ratio (ethylene-α-olefin copolymer/diene-based rubber) of the ethylene-α-olefin copolymer to the diene-based rubber is preferably 55/45 or more, more preferably or more, and even more preferably 70/30 or more, and is preferably 95/5 or less, more preferably 90/10 or less, and even more preferably 85/15 or less in the base rubber.

### (Petroleum Resin)

The rubber composition contains a petroleum resin. The petroleum resin increases the friction coefficient of the sheet conveyance roller. The petroleum resin may be used solely, or at least two of them may be used in combination.

The petroleum resin is a resin obtained by polymerizing or copolymerizing a petroleum fraction that is obtained as a by-product when pyrolyzing a petroleum-based compound such as naphtha to produce an olefin such as ethylene. It is noted that the material of the petroleum resin is not necessarily all the petroleum fraction, and may include a chemically synthesized unsaturated compound.

Examples of the petroleum fraction include aliphatic olefins having 4 to 10 carbon atoms, aliphatic diolefins having 4 to 10 carbon atoms, and aromatic compounds having an olefinic unsaturated bond and 8 or more carbon atoms.

Examples of the aliphatic olefins having 4 to 10 carbon atoms include butene, pentene, hexene, and heptene. Examples of the aliphatic diolefins having 4 to 10 carbon atoms include butadiene, pentadiene, isoprene, cyclopentadiene, dicyclopentadiene, and methylpentadiene. Examples of the aromatic compounds having the olefinic unsaturated bond and 8 or more carbon atoms include styrene, α-methylstyrene, 6-methylstyrene, vinyltoluene, vinylxylene, indene, methylindene, and ethylindene.

Examples of the chemically synthesized unsaturated compound include cyclopentadiene and dicyclopentadiene (DCPD).

Examples of the petroleum resin include an aliphatic petroleum resin obtained by polymerizing the aliphatic olefin and/or aliphatic diolefin; an aromatic petroleum resin obtained by polymerizing the aromatic compound having the olefinic unsaturated bond; an aliphatic-aromatic copolymerized petroleum resin obtained by copolymerizing the aliphatic olefin and/or aliphatic diolefin and the aromatic compound having the olefinic unsaturated bond; a dicyclopentadiene-based petroleum resin obtained by polymerizing cyclopentadiene or dicyclopentadiene; and a dicyclopentadiene-aromatic copolymerized petroleum resin obtained by copolymerizing cyclopentadiene or dicyclopentadiene and the aromatic compound having the olefinic unsaturated bond. In addition, the aromatic petroleum resin also includes a styrene-based resin obtained by polymerizing a styrene-based compound (styrene, α-methylstyrene, p-methylstyrene).

In addition, as the petroleum resin, a hydrogenated petroleum resin may be used. The hydrogenated petroleum resin is obtained by adding a hydrogen atom to the polymer that is obtained by polymerizing the petroleum fraction or the chemically synthesized unsaturated compound. If the hydrogen atom is added, the double bond in the molecule is hydrogenated. The hydrogenated product includes a fully hydrogenated petroleum resin having all the double bonds in the molecule hydrogenated, and a partially hydrogenated petroleum resin having a part of the double bonds in the molecule hydrogenated, and each of them may be used.

Examples of the hydrogenated petroleum resin include a hydrogenated aliphatic petroleum resin obtained by hydrogenating the aliphatic petroleum resin; a hydrogenated aromatic petroleum resin obtained by hydrogenating the aromatic petroleum resin; a hydrogenated aliphatic-aromatic copolymerized petroleum resin obtained by hydrogenating the aliphatic-aromatic copolymerized petroleum resin; a hydrogenated dicyclopentadiene-based petroleum resin obtained by hydrogenating the dicyclopentadiene-based petroleum resin; and a hydrogenated dicyclopentadiene-aromatic copolymerized petroleum resin obtained by hydrogenating the dicyclopentadiene-aromatic copolymerized petroleum resin.

The petroleum resin preferably includes at least one resin selected from the group consisting of the aliphatic petroleum resin, the aromatic petroleum resin, the aliphatic-aromatic copolymerized petroleum resin, the dicyclopentadiene-based petroleum resin, the dicyclopentadiene-aromatic copolymerized petroleum resin, the hydrogenated aliphatic petroleum resin, the hydrogenated aromatic petroleum resin, the hydrogenated aliphatic-aromatic copolymerized petroleum resin, the hydrogenated dicyclopentadiene-based petroleum resin, and the hydrogenated dicyclopentadiene-aromatic copolymerized petroleum resin.

It is noted that in the case that the rubber composition contains an organic peroxide as a vulcanizing agent which will be described later, the petroleum resin preferably includes at least one resin selected from the group consisting of the hydrogenated aliphatic petroleum resin, the hydrogenated aromatic petroleum resin, the hydrogenated aliphatic-aromatic copolymerized petroleum resin, the hydrogenated dicyclopentadiene-based petroleum resin, and the hydrogenated dicyclopentadiene-aromatic copolymerized petroleum resin. By such a configuration, the obtained sheet conveyance roller has further enhanced abrasion resistance.

In addition, in the case that the rubber composition contains the diene-based rubber as the base rubber and contains the organic peroxide as the vulcanizing agent which will be described later, the petroleum resin preferably includes at least one resin selected from the group consisting of the hydrogenated aliphatic petroleum resin, the hydrogenated aromatic petroleum resin, the hydrogenated aliphatic-aromatic copolymerized petroleum resin, the hydrogenated dicyclopentadiene-based petroleum resin, and the hydrogenated dicyclopentadiene-aromatic copolymerized petroleum resin. By such a configuration, the obtained sheet conveyance roller has enhanced abrasion resistance.

The softening point of the petroleum resin is preferably 50° C. or more, more preferably 60° C. or more, and even more preferably 70° C. or more, and is preferably 150° C. or less, more preferably 140° C. or less, and even more preferably 130° C. or less. If the softening point is 50° C. or more, the resin is easily handled during storage or metering, and if the softening point is 150° C. or less, the resin is easily softened when being kneaded, and thus is easily kneaded. It is noted that the softening point of the petroleum resin is measured according to 7.7 Softening point in JIS K6220-1 (2015).

The amount of the petroleum resin in the rubber composition is preferably 1.0 part by mass or more, more preferably 1.5 parts by mass or more, and even more preferably 2.0 parts by mass or more, and is preferably 15 parts by mass or less, more preferably 14 parts by mass or less, and even more preferably 12 parts by mass or less, with respect to 100 parts by mass of the base rubber. If the amount of the petroleum resin is 1.0 part by mass or more, the sheet conveyance roller has further enhanced friction coefficient, and if the amount of the petroleum resin is 15 parts by mass or less, adhesion to the inner wall of the apparatus during kneading is suppressed, and the processibility is better.

### (Vulcanizing Agent)

The rubber composition preferably contains a sulfur-based vulcanizing agent, or an organic peroxide as a vulcanizing agent. If the vulcanizing agent is contained, the obtained sheet conveyance roller has further enhanced abrasion resistance.

Examples of the sulfur-based vulcanizing agent include an elemental sulfur, and a sulfur donor type compound. Examples of the elemental sulfur include powdery sulfur, precipitated sulfur, colloidal sulfur, and insoluble sulfur. Examples of the sulfur donor type compound include 4,4′-dithiobismorpholine.

Examples of the organic peroxide include dicumyl peroxide, α,α′-bis(t-butylperoxy-m-diisopropyl)benzene, 2,5-dimethyl-2,5-di(t-butylperoxy)hexane, and 1,1-bis(t-butylperoxy)3,3,5-trimethylcyclohexane. The vulcanizing agent may be used solely, or at least two of them may be used in combination.

In the case that the vulcanizing agent is contained, the amount of the vulcanizing agent is preferably 0.5 part by mass or more, more preferably 0.8 part by mass or more, and even more preferably 1.0 part by mass or more, and is preferably 3.0 parts by mass or less, more preferably 2.7 parts by mass or less, and even more preferably 2.5 parts by mass or less, with respect to 100 parts by mass of the base rubber. If the amount of the vulcanizing agent is 0.5 part by mass or more, the formed roller has further enhanced abrasion resistance, and if the amount of the vulcanizing agent is 3.0 parts by mass or less, the formed roller has a not excessively high hardness, and the friction coefficient is better.

### (Vulcanization Accelerator)

The rubber composition may contain a vulcanization accelerator. As the vulcanization accelerator, an inorganic accelerator or an organic accelerator may be used. Examples of the inorganic accelerator include slaked lime, magnesia (MgO), and litharge (PbO). Examples of the organic accelerator include a thiazole-based accelerator, a thiuram-based accelerator, a sulfenamide-based accelerator, and a dithiocarbamate-based accelerator. The vulcanization accelerator may be used solely, or at least two of them may be used in combination. As the vulcanization accelerator used together with the sulfur-based vulcanizing agent, the thiazole-based accelerator and the thiuram-based accelerator are preferably used in combination.

Examples of the thiazole-based accelerator include 2-mercaptobenzothiazole, di-2-benzothiazolyldisulfide, zinc salt of 2-mercaptobenzothiazole, cyclohexylamine salt of 2-mercaptobenzothiazole, 2-(N,N-diethylthiocarbamoylthio)benzothiazole, and 2-(4′-morpholinodithio)benzothiazole, and di-2-benzothiazolyldisulfide is preferable.

Examples of the thiuram-based accelerator include tetramethylthiuram monosulfide, tetramethylthiuram disulfide, tetraethylthiuram disulfide, tetrabutylthiuram disulfide, tetrakis(2-ethylhexyl)thiuram disulfide, and dipentamethylenethiuram tetrasulfide, and tetramethylthiuram monosulfide is preferable.

The amount of the thiazole-based accelerator is preferably 0.1 part by mass or more and 10 parts by mass or less with respect to 100 parts by mass of the base rubber.

The amount of the thiuram-based accelerator is preferably 0.1 part by mass or more and 10 parts by mass or less with respect to 100 parts by mass of the base rubber.

### (Vulcanization Acceleration Aid)

The rubber composition may contain a vulcanization acceleration aid. Examples of the vulcanization acceleration aid include zinc oxide. The amount of the vulcanization acceleration aid is preferably 1 part by mass or more and 10 parts by mass or less with respect to 100 parts by mass of the base rubber.

### (Other Component)

The rubber composition may contain additives generally used as the additives for a rubber, such as a filler, a processing aid, an antioxidant, a peptizing agent, and a pigment, as long as the gist of the present disclosure is not impaired.

As the filler, a filler generally used for a rubber may be used, and examples thereof include carbon black, silica, calcium carbonate, talc, clay, magnesium carbonate, and aluminum oxide, and carbon black or calcium carbonate is preferable. If the filler is contained, the obtained roller has enhanced mechanical strength.

The amount of the filler is preferably 3 parts by mass or more, more preferably 5 parts by mass or more, and even more preferably 10 parts by mass or more, and is preferably 100 parts by mass or less, more preferably 70 parts by mass or less, even more preferably 50 parts by mass or less, and most preferably 28 parts by mass or less, with respect to 100 parts by mass of the base rubber.

Examples of the processing aid include a fatty acid having 12 to 30 carbon atoms (such as stearic acid), a fatty acid ester, a fatty acid metal salt, a fatty acid amide, a hydrocarbon (paraffin), and a process oil.

Examples of the antioxidant include nickel diethyldithiocarbamate, and nickel dibutyldithiocarbamate.

The hardness of the cured product of the rubber composition (Type A hardness according to Durometer Method) is preferably 10 or more, more preferably 15 or more, and even more preferably 20 or more, and is preferably 90 or less, more preferably 85 or less, and even more preferably 80 or less. If the hardness of the cured product is 10 or more, the hardness is suitable for the sheet conveyance, and the conveyance performance is further enhanced, and if the hardness of the cured product is 90 or less, the press fitting of the roller axis is easier.

### <Production of Sheet Conveyance Roller Rubber Composition>

The sheet conveyance roller rubber composition is prepared by kneading the base rubber and other materials added where necessary with a kneader, a Banbury mixer, an open roll or the like. The kneading method and condition are suitably selected according to the production scale.

As the production method of the rubber composition, a method of kneading the petroleum resin and the base rubber containing the ethylene-α-olefin copolymer at a temperature equal to or higher than the softening point of the petroleum resin is preferable. In other words, the sheet conveyance roller rubber composition is preferably obtained by kneading the petroleum resin and the base rubber containing the ethylene-α-olefin copolymer at the temperature equal to or higher than the softening point of the petroleum resin.

The mixing temperature when mixing the base rubber and the petroleum resin (material temperature) is preferably a temperature equal to or higher than the softening point of the petroleum resin. If the mixing is performed at the temperature equal to or higher than the softening point of the petroleum resin, the petroleum resin is uniformly mixed in the rubber. It is noted that in the case that a plurality of petroleum resins are contained, the mixing is performed at a temperature equal to or higher than the softening point of the petroleum resin having the highest softening point. The mixing temperature is more preferably T+3° C. or more, and even more preferably T+5° C. or more when the petroleum resin has the softening point of T ° C. It is noted that in the case that a plurality of petroleum resins are contained, the softening point of the petroleum resin having the highest softening point is deemed as T ° C. The upper limit of the mixing temperature is not particularly limited, but it is generally less than 200° C.

In the case that the rubber composition contains the vulcanizing agent, the production method of the rubber composition preferably comprises a first step of kneading the petroleum resin and the base rubber containing the ethylene-α-olefin copolymer at a temperature equal to or higher than the softening point of the petroleum resin to obtain a kneaded product; and a second step of mixing the vulcanizing agent in the kneaded product. If the first step and the second step are comprised, the petroleum resin is uniformly dispersed in the rubber component, and scorch caused by the vulcanizing agent is suppressed.

In the first step, the base rubber and the petroleum resin are mixed to prepare a mixture. The mixing temperature (material temperature) when mixing the base rubber and the petroleum resin is preferably a temperature equal to or higher than the softening point of the petroleum resin. If the mixing is performed at the temperature equal to or higher than the softening point of the petroleum resin, the petroleum resin is uniformly mixed in the rubber. It is noted that in the case that a plurality of petroleum resins are contained, the mixing is performed at a temperature equal to or higher than the softening point of the petroleum resin having the highest softening point. The mixing temperature of the first step is more preferably T+3° C. or more, and even more preferably T+5° C. or more when the petroleum resin has the softening point of T ° C. The upper limit of the mixing temperature of the first step is not particularly limited, but it is generally less than 200° C. It is noted that in the case that a plurality of petroleum resins are contained, the softening point of the petroleum resin having the highest softening point is deemed as T ° C.

The mixing of the first step may be conducted with a kneader, a Banbury mixer, an open roll or the like, and is preferably conducted with the kneader.

In the first step, only the base rubber and the petroleum resin may be mixed, or other components (vulcanization acceleration aid, filler, processing aid, and antioxidant) except the vulcanizing agent may further be mixed. It is noted that in the first step, the vulcanizing agent and the vulcanization accelerator are not mixed.

In the second step, the mixture and the vulcanizing agent are mixed to prepare the rubber composition. The mixing temperature (material temperature) when mixing the mixture and the vulcanizing agent is preferably 30° C. or more, more preferably 40° C. or more, and even more preferably 50° C. or more, and is preferably 150° C. or less, more preferably 120° C. or less, and even more preferably 100° C. or less. If the mixing temperature is 30° C. or more, the vulcanizing agent is more easily mixed due to plasticization of the rubber, and if the mixing temperature is 150° C. or less, scorch is suppressed.

The mixing of the second step may be conducted with a kneader, a Banbury mixer, an open roll or the like, and is preferably conducted with the open roll.

In the case that the rubber composition contains the vulcanization acceleration aid, the vulcanization acceleration aid is preferably added in the second step. In the case that the rubber composition contains the filler, processing aid or antioxidant, these components are preferably added in the first step.

### <Sheet Conveyance Roller>

The sheet conveyance roller according to the present disclosure is molded from the sheet conveyance roller rubber composition.

Examples of the shape of the sheet conveyance roller include a cylindrical shape, a columnar shape, a polygonal-tubular shape, and a polygonal-columnar shape. In the case that the sheet conveyance roller has the cylindrical shape or the polygonal-tubular shape, the sheet conveyance roller preferably comprises a shaft. The material of the shaft is not particularly limited, and examples thereof include a metal, a ceramic, and a resin.

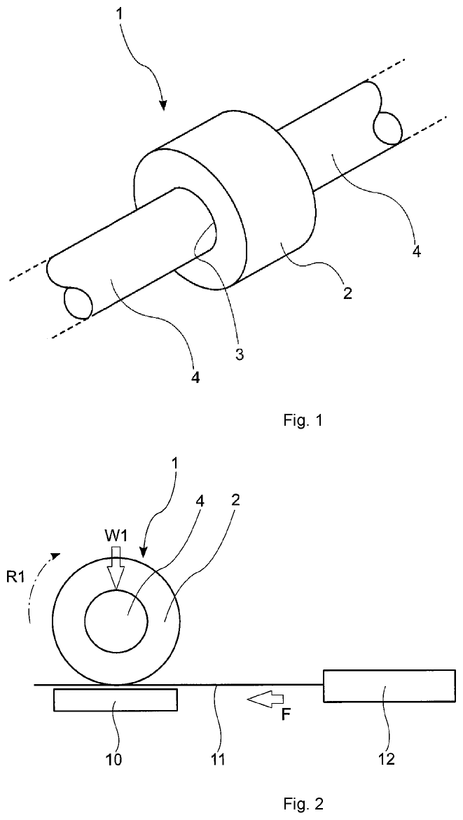

FIG. 1 shows one example of the sheet conveyance roller. The sheet conveyance roller 1 shown in FIG. 1 comprises a roller body 2 formed into a tubular shape from the above-described rubber composition according to the present disclosure. A through hole 3 having a circular cross-section is provided at the center of the roller body 2, and a shaft 4 having a columnar shape which is connected to a driving system (not shown in the figure) is inserted into the through hole 3 and fixed to the roller body 2. The outer peripheral surface of the roller body 2 is formed into a tubular shape which is concentric with the through hole 3 and the shaft 4.

The roller body 2 and the shaft 4 are fixed to each other, for example, by press fitting of the shaft 4 having an outer diameter greater than the inner diameter of the through hole 3 into the through hole 3 of the roller body 2 such that idle running does not occur. In other words, due to an interference based on a difference in diameter between the shaft 4 and the through hole 3, a certain idle running torque (limit torque which does not cause idle running) is secured therebetween.

The shaft 4 is made of, for example, a metal, a ceramic, a hard resin or the like. A plurality of the roller bodies 2 may be fixed to a plurality of locations on one shaft 4, where necessary.

Examples of the method for producing the roller body 2 include a method of molding the rubber composition into a tubular shape by an extrusion molding method followed by crosslinking the rubber composition by a press crosslinking method; and a method of molding the rubber composition into a tubular shape by a transfer molding method and simultaneously crosslinking the rubber composition.

The outer peripheral surface of the roller body 2 may be grinded such that the outer peripheral surface of the roller body 2 has a predetermined surface roughness, knurling processed, or embossment processed where necessary at any time during the above production steps. In addition, both terminals of the roller body 2 may be cut such that the outer peripheral surface has a predetermined width. The outer peripheral surface of the roller body 2 may be coated with any coating layer.

In addition, the roller body 2 may be formed of a dual layered structure composed of an outer layer on the side of the outer peripheral surface, and an inner layer on the side of the through hole 3. In this case, at least the outer layer is preferably formed from the above-described rubber composition according to the present disclosure. However, the roller body 2 is preferably a single layered structure as shown in FIG. 1 in consideration of construction simplification and productivity improvement as well as production cost reduction.

In addition, the roller body 2 may be a porous structure. However, the roller body 2 is preferably a substantially non-porous structure so as to enhance abrasion resistance, reduce permanent compression set, or unlikely cause dents by deformation even if a state contacting with one spot continues for a relative long period of time.

The through hole 3 may be provided eccentrically from the center of the roller body 2 depending on the application of the sheet conveyance roller 1. In addition, the outer peripheral surface of the roller body 2 may have an irregular shape rather than the tubular shape, such as a shape having a part of the tubular outer peripheral surface cut into a planar shape or the like. The sheet conveyance roller 1 provided with the roller body 2 having the irregular shape may be produced directly by molding the roller body 2 having the irregular shape followed by crosslinking the roller body 2 having the irregular shape by the above-described production method, or produced by processing the tubularly shaped roller body 2 into the irregular shape by post-processing.

In addition, the shaft 4 having an irregular shape corresponding to the irregular shape of the roller body 2 may be pressed into the through hole 3 of the tubularly shaped roller body 2, to deform the roller body 2 into the irregular shape.

In this case, the processibility can be enhanced since the grinding, knurling processing, embossment processing of the outer peripheral surface 5 can be performed to the tubularly shaped outer peripheral surface 5 before the deformation.

### <Image Forming Apparatus>

The sheet conveyance roller according to the present disclosure is assembled into various image forming apparatuses utilizing electrophotography, such as a laser printer, an electrostatic copying machine, a plain paper facsimile machine, and a multifunction peripheral thereof. In addition, the sheet conveyance roller according to the present disclosure can also be assembled into, for example, an ink-jet printer or ATM.

The sheet conveyance roller according to the present disclosure frictionally conveys the sheet while rotating being in contact with the sheet. Examples of the sheet include a cut sheet (cut paper), and a continuous sheet such as a continuous paper (roll paper). The sheet conveyance roller is used as, for example, a paper feeding roller, a conveyance roller, a platen roller, and a paper discharging roller.

### EXAMPLES

Hereinafter, the present disclosure will be described in detail by way of examples. However, the present disclosure is not limited to the examples described below, and various changes and modifications without departing from the gist of the present disclosure are included in the scope of the present disclosure.

### [Evaluation Method]

### (1) Hardness

The hardness of the cured products of the rubber compositions was measured according to JIS K6253-3 (2012). Specifically, sheets with a thickness of 2 mm were produced by pressing the rubber compositions at a temperature of 170° C. for minutes. At least three of these sheets were stacked on one another so as not to be affected by the measuring substrate on which the sheets were placed, the stack was contacted with a pressing plate of a Type A Durometer, and the hardness values were read in 3 seconds after the contacting.

### (2) Tensile Strength and Elongation at Break

The tensile strength and elongation at break of the cured product of the rubber composition were measured according to JIS K6251 (2017). Specifically, the rubber compositions were pressed at a temperature of 170° C. for 20 minutes to prepare sheets with a thickness of 2 mm, and the sheets were punched into a dumbbell shape (Dumbbell-shaped Type 3, thickness of parallel part: 2 mm, initial gauge length: 20 mm) to prepare test pieces. A tensile tester was used to measure the properties of the test pieces (measuring temperature: 23° C., tensile speed: 500 mm/min). The maximum tensile force recorded when stretching the test pieces until the test pieces were broken was divided by the cross-sectional area of the test pieces before the test to calculate the tensile strength.

### (3) Measurement of Friction Coefficient

As shown in FIG. 2, a plain paper 11 (P paper (width: 60 mm, length: 210 mm) available from FUJIFILM Business Innovation Corp.) was placed on a horizontally disposed plate 10 made of polytetrafluoroethylene (PTFE). The roller body 2 of the sheet conveyance roller 1 was placed on the paper 11, and a vertical load W1 (=300 gf) was applied to the shaft 4 to press the roller body 2 on the plate 10.

Subsequently, when the roller body 2 was continuously rotated in a direction shown by a single dot-dashed line arrow R1 at 200 rpm for 10 minutes under an environment of a temperature: 23° C. and a relative humidity: 55%, a conveyance force F (gf) added to a load cell 12 connected to one end of the paper 11 was measured.

The initial friction coefficient μ was calculated from the measured conveyance force F and the vertical load W1 (=300 gf) according to the formula (1).

μ=F(gf)/W1(gf) (1)

### (4) Forced Abrasion Test

As shown in FIG. 2, a plain paper 11 (P paper available from FUJIFILM Business Innovation Corp.) was placed on a horizontally disposed plate 10 made of polytetrafluoroethylene (PTFE). The roller body 2 of the sheet conveyance roller 1 was placed on the paper 11, and a vertical load W1 (=500 gf) was applied to the shaft 4 to press the roller body 2 on the plate 10.

Subsequently, the roller body 2 was continuously rotated in a direction shown by a single dot-dashed line arrow R1 at 200 rpm for 10 minutes under an environment of a temperature: 23° C. and a relative humidity: 55%. Then, the abrasion loss (%) was calculated from the mass W₀ (g) of the roller body 2 before the rotation and the mass W₁ (g) of the roller body 2 after the rotation according to the following formula (2).

Abrasion loss (%)=100×(W₀−W₁)/W₀ (Formula 2)

### [Preparation of Rubber Composition]

According to the formulations shown in Tables 1 to 3, the materials were mixed to prepare the rubber compositions. Specifically, firstly, the base rubber, the petroleum resin and the filler were mixed with a kneader to prepare mixtures. At this time, the mixing was conducted for one minute after the temperature (material temperature) in the tank of the kneader reached a predetermined temperature. Subsequently, the obtained mixture was cooled, and the mixture, the vulcanizing agent, the vulcanization accelerator and the vulcanization acceleration aid were mixed with an open roll having a surface temperature controlled to 30° C. to 50° C., to prepare rubber compositions. The measurement results of the cured products of the obtained rubber compositions are shown in Tables 1 to 3.

TABLE 1

| | | | Rubber composition No. | | | | | | | |
|---|---|---|---|---|---|---|---|---|---|---|
| | | | 1 | 2 | 3 | 4 | 5 | 6 | 7 | 8 |
| Formulation | Base rubber | EPDM 1 | 100 | 100 | 100 | 100 | 100 | 100 | 100 | 100 |
| (parts by | | EPDM 2 | — | — | — | — | — | — | — | — |
| mass) | | EPDM 3 | — | — | — | — | — | — | — | — |
| | | SBR | — | — | — | — | — | — | — | — |
| | | IR | — | — | — | — | — | — | — | — |
| | Petroleum resin | Petroleum resin 1 | 4 | — | — | — | — | — | — | — |
| | | Petroleum resin 2 | — | 3 | — | — | — | — | — | — |
| | | Petroleum resin 3 | — | — | 6 | — | — | — | — | — |
| | | Petroleum resin 4 | — | — | — | 5 | — | — | — | — |
| | | Petroleum resin 5 | — | — | — | — | 5 | — | — | — |
| | | Petroleum resin 6 | — | — | — | — | — | 2 | — | — |
| | | Petroleum resin 7 | — | — | — | — | — | — | 4 | — |
| | | Petroleum resin 8 | — | — | — | — | — | — | — | — |
| | Filler | Carbon black | 0.5 | 0.5 | 0.5 | 0.5 | 0.5 | 0.5 | 0.5 | 0.5 |
| | | Calcium carbonate | 25 | 25 | 25 | 25 | 25 | 25 | 25 | 25 |
| | Vulcanization | Zinc oxide | 5 | 5 | 5 | 5 | 5 | 5 | 5 | 5 |
| | acceleration aid | Stearic acid | 1 | 1 | 1 | 1 | 1 | 1 | 1 | 1 |
| | Vulcanizing agent | Sulfur | 1 | 1 | 1 | 1 | 1 | 1 | 1 | 1 |
| | Vulcanization | Vulcanization accelerator 1 | 3 | 3 | 3 | 3 | 3 | 3 | 3 | 3 |
| | accelerator | Vulcanization accelerator 2 | 2 | 2 | 2 | 2 | 2 | 2 | 2 | 2 |
| | Vulcanizing agent | Organic peroxide | — | — | — | — | — | — | — | — |

| Kneading temperature with kneader [° C.] | | 110 | 110 | 110 | 110 | 110 | 110 | 110 | 110 |
|---|---|---|---|---|---|---|---|---|---|
| Evaluation on | Hardness | 50 | 50 | 48 | 50 | 50 | 50 | 49 | 51 |
| cured product | Tensile strength [MPa] | 2.0 | 2.0 | 1.7 | 2.4 | 2.2 | 2.0 | 1.9 | 2.1 |
| | Elongation at break [%] | 350 | 355 | 360 | 420 | 375 | 345 | 330 | 350 |
| Evaluation on | Friction coefficient | 2.07 | 2.04 | 1.85 | 1.91 | 1.90 | 1.98 | 1.97 | 1.65 |
| roller | Abrasion loss [%] | 0.05 | 0.05 | 0.06 | 0.17 | 0.11 | 0.06 | 0.06 | 0.05 |

TABLE 2

| | | | Rubber composition No. | | | | | | |
|---|---|---|---|---|---|---|---|---|---|
| | | | 9 | 10 | 11 | 12 | 13 | 14 | 15 |
| Formulation | Base rubber | EPDM 1 | 100 | 100 | 100 | 100 | 100 | 100 | 100 |
| (parts by | | EPDM 2 | — | — | — | — | — | — | — |
| mass) | | EPDM 3 | — | — | — | — | — | — | — |
| | | SBR | — | — | — | — | — | — | — |
| | | IR | — | — | — | — | — | — | — |
| | Petroleum resin | Petroleum resin 1 | 10 | — | — | — | — | — | — |
| | | Petroleum resin 2 | — | 6 | — | — | — | — | — |
| | | Petroleum resin 3 | — | — | 5 | — | — | — | — |
| | | Petroleum resin 4 | — | — | — | — | — | — | — |
| | | Petroleum resin 5 | — | — | — | — | — | — | — |
| | | Petroleum resin 6 | — | — | — | 4 | — | — | — |
| | | Petroleum resin 7 | — | — | — | — | 8 | — | — |
| | | Petroleum resin 8 | — | — | — | — | — | 7 | — |
| | Filler | Carbon black | 0.5 | 0.5 | 0.5 | 0.5 | 0.5 | 0.5 | 0.5 |
| | | Calcium carbonate | 25 | 25 | 25 | 25 | 25 | 25 | 25 |
| | Vulcanization | Zinc oxide | — | — | — | — | — | — | — |
| | acceleration aid | Stearic acid | — | — | — | — | — | — | — |
| | Vulcanizing agent | Sulfur | — | — | — | — | — | — | — |
| | Vulcanization | Vulcanization accelerator 1 | — | — | — | — | — | — | — |
| | accelerator | Vulcanization accelerator 2 | — | — | — | — | — | — | — |
| | Vulcanizing agent | Organic peroxide | 3 | 3 | 3 | 3 | 3 | 3 | 3 |

| Kneading temperature with kneader [° C.] | | 110 | 110 | 110 | 110 | 110 | 110 | 110 |
|---|---|---|---|---|---|---|---|---|
| Evaluation on | Hardness | 53 | 52 | 51 | 52 | 53 | 56 | 56 |
| cured product | Tensile strength [MPa] | 2.1 | 2.3 | 2.4 | 2.3 | 2.4 | 2.6 | 2.2 |
| | Elongation at break [%] | 260 | 330 | 375 | 310 | 230 | 272 | 220 |
| Evaluation on | Friction coefficient | 2.00 | 1.91 | 1.88 | 2.04 | 2.02 | 1.92 | 1.60 |
| roller | Abrasion loss [%] | 0.08 | 0.08 | 0.09 | 0.12 | 0.10 | 0.08 | 0.21 |

TABLE 3

| | | | Rubber composition No. | | | | | | | | | |
|---|---|---|---|---|---|---|---|---|---|---|---|---|
| | | | 16 | 17 | 18 | 19 | 20 | 21 | 22 | 23 | 24 | 25 |
| Formulation | Base rubber | EPDM 1 | — | — | — | — | 70 | 70 | 70 | 60 | 60 | 60 |
| (parts by | | EPDM 2 | 50 | 50 | 50 | 50 | — | — | — | — | — | — |
| mass) | | EPDM 3 | 75 | 75 | 75 | 75 | — | — | — | — | — | — |
| | | SBR | — | — | — | — | 30 | 30 | 30 | — | — | — |
| | | IR | — | — | — | — | — | — | — | 40 | 40 | 40 |
| | Petroleum resin | Petroleum resin 1 | 3 | — | — | — | — | — | — | — | — | — |
| | | Petroleum resin 2 | — | — | — | — | — | — | — | — | — | — |
| | | Petroleum resin 3 | — | — | — | — | — | — | — | — | — | — |
| | | Petroleum resin 4 | — | — | — | — | 2 | — | — | 2 | 3 | — |
| | | Petroleum resin 5 | — | — | — | — | 5 | 2 | — | — | — | — |
| | | Petroleum resin 6 | — | 5 | — | — | — | 4 | — | 5 | — | — |
| | | Petroleum resin 7 | — | — | 4 | — | — | — | — | — | 3 | — |
| | | Petroleum resin 8 | — | — | — | — | — | — | — | — | — | — |
| | Filler | Carbon black | 5 | 5 | 5 | 5 | 0.5 | 0.5 | 0.5 | 0.5 | 0.5 | 0.5 |
| | | Calcium carbonate | — | — | — | — | 25 | 25 | 25 | 25 | 25 | 25 |
| | Vulcanization | Zinc oxide | — | — | — | — | — | — | — | — | — | — |
| | acceleration aid | Stearic acid | — | — | — | — | — | — | — | — | — | — |
| | Vulcanizing agent | Sulfur | — | — | — | — | — | — | — | — | — | — |
| | Vulcanization | Vulcanization accelerator 1 | — | — | — | — | — | — | — | — | — | — |
| | accelerator | Vulcanization accelerator 2 | — | — | — | — | — | — | — | — | — | — |
| | Vulcanizing agent | Organic peroxide | 3 | 3 | 3 | 3 | 2.5 | 2.5 | 2.5 | 3 | 3 | 3 |

| Kneading temperature with kneader [° C.] | | 110 | 110 | 110 | 110 | 110 | 110 | 110 | 110 | 110 | 110 |
|---|---|---|---|---|---|---|---|---|---|---|---|
| Evaluation | Hardness | 49 | 47 | 49 | 51 | 51 | 55 | 61 | 47 | 47 | 53 |
| on cured | Tensile strength [MPa] | 3.3 | 3.6 | 4.0 | 4.1 | 3.5 | 6.0 | 7.0 | 2.3 | 2.2 | 1.9 |
| product | Elongation at break [%] | 400 | 440 | 390 | 325 | 250 | 240 | 200 | 340 | 340 | 200 |
| Evaluation | Friction coefficient | 1.84 | 1.79 | 1.88 | 1.53 | 1.81 | 1.75 | 1.44 | 2.14 | 2,19 | 1.99 |
| on roller | Abrasion loss [%] | 0.07 | 0.11 | 0.09 | 0.08 | 0.34 | 0.21 | 0.16 | 0.30 | 0.30 | 0.08 |

* EPDM 2 in No. 16 to 19 includes 25 parts by mass of EPDM component and 25 parts by mass of an extending oil.

The materials used in Tables 1 to 3 are shown below.

EPDM 1: “ESPRENE (registered trademark) 505A” (non-oil extended EPDM) (ethylene-propylene-ethylidene norbornene copolymer, amount of ethylene: 50 mass %, amount of diene component: 9.5 mass %) available from Sumitomo Chemical Co., Ltd.

EPDM 2: “ESPRENE 670F” (oil extended EPDM) (amount of ethylene: 66 mass %, amount of diene component: 4.0 mass %, amount of oil with respect to 100 parts by mass of EPDM: 100 parts by mass) available from Sumitomo Chemical Co., Ltd.

EPDM 3: “ESPRENE 586” (non-oil extended EPDM) (amount of ethylene: 66 mass %, amount of diene component: 12.5 mass %) available from Sumitomo Chemical Co., Ltd.

SBR: “Nipol (registered trademark) 1502” (non-oil extended styrene butadiene rubber, bound styrene: 23.5 mass %, Mooney viscosity ML₁₊₄ (100° C.): 52.0) available from Zeon Corporation

IR: “Nipol (registered trademark) IR2200” (isoprene rubber) available from Zeon Corporation

Petroleum resin 1: “T-REZ (registered trademark) HA085” (hydrogenated dicyclopentadiene-based petroleum resin, softening point: 88.0° C.) available from ENEOS Inc.

Petroleum resin 2: “T-REZ PR801” (hydrogenated dicyclopentadiene-aromatic copolymerized petroleum resin, softening point: 90.0° C.) available from ENEOS Inc.

Petroleum resin 3: “T-REZ RB093” (aliphatic petroleum resin, softening point: 93.0° C.) available from ENEOS Inc.

Petroleum resin 4: “PETROTACK (registered trademark) 100V” (aliphatic-aromatic copolymerized petroleum resin, softening point: 96° C.) available from Tosoh Corporation

Petroleum resin 5: “PETCOAL (registered trademark) LX” (aromatic petroleum resin, softening point: 98° C.) available from Tosoh Corporation

Petroleum resin 6: “ARKON (registered trademark) M-100” (partially hydrogenated aromatic petroleum resin, softening point: 100° C.) available from Arakawa Chemical Industries, Ltd.

Petroleum resin 7: “ARKON P-100” (fully hydrogenated aromatic petroleum resin, softening point: 100° C.) available from Arakawa Chemical Industries, Ltd.

Petroleum resin 8: “YS Resin SX100” (styrene-based resin, softening point: 100° C.) available from Yasuhara Chemical Co., Ltd.

Carbon black: SEAST (registered trademark) 3 available from Tokai Carbon Co., Ltd.

Calcium carbonate: BF-300 available from Bihoku Funka Kogyo Co., Ltd.

Zinc oxide: zinc oxide Type II available from Mitsui Mining & Smelting Co., Ltd.

Stearic acid: stearic acid Tsubaki available from NOF Corporation

Sulfur: 5% oil treated sulfur available from Tsurumi Chemical Industry Co., Ltd.

Vulcanization accelerator 1: “Nocceler (registered trademark) TOT-N” (tetrakis(2-ethylhexyl)thiuram disulfide) available from Ouchi Shinko Chemical Industrial Co., Ltd.

Vulcanization accelerator 2: “Nocceler DM” (di-2-benzothiazyldisulfide) available from Ouchi Shinko Chemical Industrial Co., Ltd.

Organic peroxide: “Percumyl (register trademark) D” available from NOF Corporation

### [Production of Sheet Conveyance Roller]

The rubber compositions obtained above were molded into a cylindrical shape with a through hole at a temperature of 170° C. for 30 minutes by a transfer molding method. A shaft (outer diameter: 12 mm) was pressed into the through hole of the cylindrically shaped molded products, the rubber roller was grinded with a cylindrical grinding machine such that the rubber roller had an outer diameter of 22 mm, and the rubber roller was cut such that the rubber roller had a width of 25 mm, to prepare the sheet conveyance rollers. The evaluation results of the obtained sheet conveyance rollers are shown in Tables 1 to 3.

The rubber compositions No. 1 to 7 are the cases containing an ethylene-α-olefin copolymer as a base rubber, a petroleum resin, and sulfur as a vulcanizing agent. The rubber composition No. 8 is a case containing an ethylene-α-olefin copolymer and sulfur and not containing a petroleum resin. The sheet conveyance rollers formed from the rubber compositions No. 1 to 7 have an improved friction coefficient than the sheet conveyance roller formed from the rubber composition No. 8 not containing the petroleum resin.

The rubber compositions No. 9 to 14 are the cases containing an ethylene-α-olefin copolymer as a base rubber, a petroleum resin, and an organic peroxide as a vulcanizing agent. The rubber composition No. 15 is a case containing an ethylene-α-olefin copolymer and an organic peroxide and not containing a petroleum resin. The sheet conveyance rollers formed from the rubber compositions No. 9 to 14 have an improved friction coefficient than the sheet conveyance roller formed from the rubber composition No. 15 not containing the petroleum resin.

The rubber compositions No. 16 to 18 are the cases containing a non-oil extended ethylene-α-olefin copolymer and an oil extended ethylene-α-olefin copolymer as a base rubber, a petroleum resin, and an organic peroxide as a vulcanizing agent. The rubber composition No. 19 is a case containing a non-oil extended ethylene-α-olefin copolymer, an oil extended ethylene-α-olefin copolymer and an organic peroxide and not containing a petroleum resin. The sheet conveyance rollers formed from the rubber compositions No. 16 to 18 have an improved friction coefficient than the sheet conveyance roller formed from the rubber composition No. 19 not containing the petroleum resin.

The rubber compositions No. 20 and 21 are the cases containing an ethylene-α-olefin copolymer and a styrene butadiene rubber as a base rubber, a petroleum resin, and an organic peroxide as a vulcanizing agent. The rubber composition No. 22 is a case containing an ethylene-α-olefin copolymer, a styrene butadiene rubber and an organic peroxide and not containing a petroleum resin. The sheet conveyance rollers formed from the rubber compositions No. 20 and 21 have an improved friction coefficient than the sheet conveyance roller formed from the rubber composition No. 22 not containing the petroleum resin.

The rubber compositions No. 23 and 24 are the cases containing an ethylene-α-olefin copolymer and an isoprene rubber as a base rubber, a petroleum resin, and an organic peroxide as a vulcanizing agent. The rubber composition No. 25 is a case containing an ethylene-α-olefin copolymer, an isoprene and an organic peroxide and not containing a petroleum resin. The sheet conveyance rollers formed from the rubber compositions No. 23 and 24 have an improved friction coefficient than the sheet conveyance roller formed from the rubber composition No. 25 not containing the petroleum resin.

The present disclosure (1) is a sheet conveyance roller rubber composition containing a base rubber and a petroleum resin, wherein the base rubber contains an ethylene-α-olefin copolymer.

The present disclosure (2) is the sheet conveyance roller rubber composition according to the present disclosure (1), wherein the petroleum resin includes at least one resin selected from the group consisting of an aliphatic petroleum resin, an aromatic petroleum resin, an aliphatic-aromatic copolymerized petroleum resin, a dicyclopentadiene-based petroleum resin, a dicyclopentadiene-aromatic copolymerized petroleum resin, a hydrogenated aliphatic petroleum resin, a hydrogenated aromatic petroleum resin, a hydrogenated aliphatic-aromatic copolymerized petroleum resin, a hydrogenated dicyclopentadiene-based petroleum resin, and a hydrogenated dicyclopentadiene-aromatic copolymerized petroleum resin.

The present disclosure (3) is the sheet conveyance roller rubber composition according to the present disclosure (1) or (2), wherein an amount of the ethylene-α-olefin copolymer is 50 mass % or more in 100 mass % of the base rubber.

The present disclosure (4) is the sheet conveyance roller rubber composition according to any one of the present disclosures (1) to (3), wherein an amount of the petroleum resin ranges from 1 part by mass to 15 parts by mass with respect to 100 parts by mass of the rubber component.

The present disclosure (5) is the sheet conveyance roller rubber composition according to any one of the present disclosures (1) to (4), wherein the sheet conveyance roller rubber composition contains an organic peroxide as a vulcanizing agent, and the petroleum resin includes at least one resin selected from the group consisting of a hydrogenated aliphatic petroleum resin, a hydrogenated aromatic petroleum resin, a hydrogenated aliphatic-aromatic copolymerized petroleum resin, a hydrogenated dicyclopentadiene-based petroleum resin, and a hydrogenated dicyclopentadiene-aromatic copolymerized petroleum resin.

The present disclosure (6) is the sheet conveyance roller rubber composition according to any one of the present disclosures (1) to (5), wherein the base rubber further contains a diene-based rubber.

The present disclosure (7) is the sheet conveyance roller rubber composition according to the present disclosure (6), wherein the diene-based rubber is an isoprene rubber and/or a natural rubber.

The present disclosure (8) is the sheet conveyance roller rubber composition according to any one of the present disclosures (1) to (7), wherein the sheet is a cut paper.

The present disclosure (9) is a sheet conveyance roller molded from the sheet conveyance roller rubber composition according to any one of the present disclosures (1) to (8).

The present disclosure (10) is a method for producing a sheet conveyance roller rubber composition containing a base rubber and a petroleum resin, comprising a step of kneading the petroleum resin and a base rubber containing an ethylene-α-olefin copolymer at a temperature equal to or higher than a softening point of the petroleum resin.

The present disclosure (11) is a method for producing a sheet conveyance roller rubber composition containing a base rubber, a petroleum resin and a vulcanizing agent, comprising: a first step of kneading the petroleum resin and a base rubber containing an ethylene-α-olefin copolymer at a temperature equal to or higher than a softening point of the petroleum resin to obtain a kneaded product; and a second step of mixing the vulcanizing agent in the kneaded product.

This application is based on Japanese patent application No. 2022-107179 filed on Jul. 1, 2022, the content of which is hereby incorporated by reference.

1. A sheet conveyance roller rubber composition containing a base rubber and a petroleum resin, wherein the base rubber contains an ethylene-α-olefin copolymer.

2. The sheet conveyance roller rubber composition according to claim 1, wherein the petroleum resin includes at least one resin selected from the group consisting of an aliphatic petroleum resin, an aromatic petroleum resin, an aliphatic-aromatic copolymerized petroleum resin, a dicyclopentadiene-based petroleum resin, a dicyclopentadiene-aromatic copolymerized petroleum resin, a hydrogenated aliphatic petroleum resin, a hydrogenated aromatic petroleum resin, a hydrogenated aliphatic-aromatic copolymerized petroleum resin, a hydrogenated dicyclopentadiene-based petroleum resin, and a hydrogenated dicyclopentadiene-aromatic copolymerized petroleum resin.

3. The sheet conveyance roller rubber composition according to claim 1, wherein an amount of the ethylene-α-olefin copolymer is 50 mass % or more in 100 mass % of the base rubber.

4. The sheet conveyance roller rubber composition according to claim 1, wherein an amount of the petroleum resin ranges from 1 part by mass to 15 parts by mass with respect to 100 parts by mass of the rubber component.

5. The sheet conveyance roller rubber composition according to claim 1, wherein the sheet conveyance roller rubber composition contains an organic peroxide as a vulcanizing agent, and
the petroleum resin includes at least one resin selected from the group consisting of a hydrogenated aliphatic petroleum resin, a hydrogenated aromatic petroleum resin, a hydrogenated aliphatic-aromatic copolymerized petroleum resin, a hydrogenated dicyclopentadiene-based petroleum resin, and a hydrogenated dicyclopentadiene-aromatic copolymerized petroleum resin.

6. The sheet conveyance roller rubber composition according to claim 1, wherein the base rubber further contains a diene-based rubber.

7. The sheet conveyance roller rubber composition according to claim 6, wherein the diene-based rubber includes an isoprene rubber and/or a natural rubber.

8. The sheet conveyance roller rubber composition according to claim 1, wherein the sheet is a cut paper.

9. A sheet conveyance roller molded from a sheet conveyance roller rubber composition containing a base rubber and a petroleum resin, wherein the base rubber contains an ethylene-α-olefin copolymer.

10. The sheet conveyance roller according to claim 9, wherein the petroleum resin includes at least one resin selected from the group consisting of an aliphatic petroleum resin, an aromatic petroleum resin, an aliphatic-aromatic copolymerized petroleum resin, a dicyclopentadiene-based petroleum resin, a dicyclopentadiene-aromatic copolymerized petroleum resin, a hydrogenated aliphatic petroleum resin, a hydrogenated aromatic petroleum resin, a hydrogenated aliphatic-aromatic copolymerized petroleum resin, a hydrogenated dicyclopentadiene-based petroleum resin, and a hydrogenated dicyclopentadiene-aromatic copolymerized petroleum resin.

11. The sheet conveyance roller according to claim 9, wherein an amount of the ethylene-α-olefin copolymer is 50 mass % or more in 100 mass % of the base rubber.

12. The sheet conveyance roller according to claim 9, wherein an amount of the petroleum resin ranges from 1 part by mass to 15 parts by mass with respect to 100 parts by mass of the rubber component.

13. The sheet conveyance roller according to claim 9, wherein the sheet conveyance roller rubber composition contains an organic peroxide as a vulcanizing agent, and
the petroleum resin includes at least one resin selected from the group consisting of a hydrogenated aliphatic petroleum resin, a hydrogenated aromatic petroleum resin, a hydrogenated aliphatic-aromatic copolymerized petroleum resin, a hydrogenated dicyclopentadiene-based petroleum resin, and a hydrogenated dicyclopentadiene-aromatic copolymerized petroleum resin.

14. The sheet conveyance roller according to claim 9, wherein the base rubber further contains a diene-based rubber.

15. The sheet conveyance roller according to claim 14, wherein the diene-based rubber is an isoprene rubber and/or a natural rubber.

16. The sheet conveyance roller according to claim 9, wherein the sheet is a cut paper.

17. A method for producing a sheet conveyance roller rubber composition containing a base rubber and a petroleum resin, comprising a step of kneading the petroleum resin and a base rubber containing an ethylene-α-olefin copolymer at a temperature equal to or higher than a softening point of the petroleum resin.

18. A method for producing a sheet conveyance roller rubber composition containing a base rubber, a petroleum resin and a vulcanizing agent, comprising:
a first step of kneading the petroleum resin and a base rubber containing an ethylene-α-olefin copolymer at a temperature equal to or higher than a softening point of the petroleum resin to obtain a kneaded product; and
a second step of mixing the vulcanizing agent in the kneaded product.
